(19) United States
(12) Patent Application Publication
(10) Pub. No.: US 2012/0183687 A1
(43) Pub. Date: Jul. 19, 2012

(54) Methods for Reducing Particulate Density

(75) Inventors: Philip D. Nguyen, Duncan, OK (US); Johnny A. Barton, Marlow, OK (US)

(73) Assignee: Halliburto Energy Services, Inc., Houston, TX (US)

(21) Appl. No.: 13/433,930

(22) Filed: Mar. 29, 2012

Related U.S. Application Data
(62) Division of application No. 10/691,319, filed on Oct. 22, 2003.

(51) Int. Cl. B05D 7/00

(52) U.S. Cl. 427/214

(57) ABSTRACT

Methods of making a reduced-density, coated particulate comprising the steps of: providing a first flowing stream comprising particulates coated with a coating material selected from the group consisting of a tackifying agent and a resin-type material; providing a second flowing stream comprising a density reducing material wherein the density reducing material is a solid material with a size that is greater than about half of the size of the coated particulates; combining the first and second flowing streams to create a third flowing stream wherein the combination of the first and second flowing streams causes the density reducing material to adhere to the coating material on the particulates so as to create reduced-density, coated particulates. The density reducing material may include solid polystyrene divinylbenzene beads.

### BACKGROUND OF THE INVENTION

The present invention provides methods for creating reduced-density, coated particulates and methods for using such particulates in subterranean operations. More particularly, the present invention relates to methods and compositions for effecting the density of particulates by coating them on-the-fly with a density-reducing material.

Particulate materials are often introduced into subterranean zones in conjunction with operations such as permeability enhancing and sand control operations. Such permeability enhancing and sand control operations may be performed as individual treatments, or may be combined where desired.

A subterranean formation may be treated to increase its permeability by hydraulically fracturing the formation to create or enhance one or more cracks or “fractures.” This is usually accomplished by injecting a viscous fracturing fluid into the subterranean formation under pressure. The fracture or fractures may be horizontal or vertical, with the latter usually predominating, and with the tendency toward vertical fractures increasing with the depth of the formation being fractured. Fracturing fluids are generally highly viscous, and may be gels, emulsions, or foams. Often, fracturing fluids comprise suspended particulate material commonly referred to as “proppant.” In some fracturing operations, commonly known as “water fracturing,” the fracturing fluid viscosity is somewhat lowered and yet the proppant remains in suspension because the treatment occurs at a substantially higher velocity. Whether a highly viscous fluid a less viscous fluid with a higher velocity is used, proppant is deposited in the fracture and functions, inter alia, to hold the fracture open while maintaining channels through which produced fluids can flow upon completion of the fracturing treatment and release of the attendant hydraulic pressure.

Sand control operations, such as gravel packing, are used to reduce the migration of unconsolidated formation sands into the well bore. One common type of gravel packing operation involves placing a gravel pack screen in the well bore and packing the surrounding annulus between the screen and the well bore with gravel of a specific size designed to prevent the passage of formation sand. The gravel pack screen is generally a filter assembly used to retain the gravel placed during the gravel pack operation. A wide range of sizes and screen configurations are available to suit the characteristics of the gravel pack sand. Similarly, a wide range of sizes of gravel is available to suit the characteristics of the unconsolidated or poorly consolidated formation sands. The resulting structure presents a barrier to migrating formation sand while allowing fluid flow. When installing the gravel pack, the gravel is generally carried to the formation in the form of a slurry by mixing the gravel with a transport fluid. Gravel packs act, inter alia, to stabilize the formation while causing minimal impairment to well productivity. The gravel, inter alia, acts to prevent the particulates from occluding the screen or migrating with the produced fluids, and the screen, inter alia, acts to prevent the gravel from entering the production tubing.

Servicing fluids, such as fracturing fluids and gravel transport fluids, generally should have sufficient viscosity to be able carry the proppant or gravel into the formation. To achieve a viscosity high enough to suspend the proppant or gravel particulates, high concentrations of viscosifiers may be added to the fracturing and transport fluids. Such viscosifiers greatly increase the cost of the fracturing and gravel packing operations, which is undesirable. Moreover, as a fracture or a gravel pack is created, a portion of the liquid contained in the servicing fluid may leak off into the formation and create a filter cake comprising deposited viscosifier on the walls of the fracture and/or the formation. While the filter cake may be beneficial in some instances (e.g. aiding in preventing servicing fluids from being lost in the formation and in preventing solids from entering the porosities of the producing formation), the filter cake becomes undesirable when the subterranean formation is returned to production. More over, residue of viscosifiers used in subterranean applications often remains on the particulates transported by the viscosified fluid. Where such particulates are proppant particulates used in a fracturing operation, for example, such residue often reduces the permeability of a proppant pack within a fracture.

### SUMMARY OF THE INVENTION

The present invention provides methods for creating reduced-density, coated particulates and methods for using such particulates in subterranean operations. More particularly, the present invention relates to methods and compositions for effecting the density of particulates by coating them on-the-fly with a density-reducing material.

One embodiment of the present invention describes methods of making a reduced-density, coated particulate comprising the steps of coating a particulate material with a coating material to create a coated particulate; providing a density-reducing material; and, adhering the density-reducing material to the surface of the coated particulate on-the-fly to create reduced-density, coated particulates.

Another embodiment of the present invention describes methods of treating a subterranean formation comprising the steps of providing a servicing fluid comprising reduced-density, coated particulates wherein the method of making the reduced-density, coated particulates comprises the steps of: coating a particulate material with a coating material to create a coated particulate; providing a density-reducing material; and, adhering the density-reducing material to the surface of the coated particulate on-the-fly to create reduced-density, coated particulates; and, pumping the servicing fluid into a subterranean formation.

Other and further features and advantages of the present invention will be readily apparent to those skilled in the art upon a reading of the description of preferred embodiments which follows.

### BRIEF DESCRIPTION OF FIGURES

FIG. 1 illustrates an embodiment of an on-the-fly mixing method of the present invention.

### DESCRIPTION OF PREFERRED EMBODIMENTS

The present invention provides methods for creating reduced-density, coated particulates and methods for using such particulates in subterranean operations. More particularly, the present invention relates to methods and compositions for effecting the density of particulates by coating them on-the-fly with a density-reducing material. When used in a subterranean treatment, the reduced-density, coated particulates may allow for the use of lower viscosity servicing fluids.

In some embodiments of the methods of the present invention, a particulate is coated with either a resin-type coating or a tackifying coating and then, while the coating is still tacky, a density reducing material is adhered to the particulate's surface on-the-fly. In some embodiments of the present invention, the density-reducing material is low-density micro-material, smaller in size than the particulate itself. In other embodiments of the present invention, the density-reducing material is low-density material similar in size to the particulate itself.

Any particulate suitable for use in subterranean applications is suitable for use as proppant or gravel in the compositions and methods of the present invention. For instance, natural sand, quartz sand, particulate garnet, glass, ground walnut hulls, nylon pellets, bauxite, ceramics, polymeric materials, carbon composites, natural or synthetic polymers, porous silica, alumina spheroids, and resin beads are suitable. Suitable sizes range from 4 to 100 U.S. mesh, in certain preferred embodiments the sizes range from 10 to 60 US mesh. The particulates may be in any form, including that of regular or irregular pellets, fibers, spheres, flakes, ribbons, beads, shavings, platelets and the like. One skilled in the art, with the benefit of this disclosure, will be able to select a size and shape particulate appropriate for the subterranean operation being performed.

The coating material may be a resin-type coating or a tackifying coating. The coating material should have sufficient tackiness such that the coating is able to adhere a density-reducing material to the particulate's surface. The coating need not cover 100% of the surface area of the particulate. Rather, it needs only cover a portion of the particulate sufficient to adhere enough density-reducing material to lower the coated particulate's density.

Where a resin-type coating material is used, it may act not only to lower the density of the particulate, but also to aid in the consolidation of the resin-coated particulates in a resultant fracture or gravel pack. Such consolidation may be desirable; for example, to reduce particulate flowback where the particulate is a proppant particulate used in a fracturing operation. Suitable such resin-type coating materials include, but are not limited to, two-component epoxy-based resins, furan-based resins, phenolic-based resins, high-temperature (HT) epoxy-based resins, and phenol/phenol formaldehyde/furfuryl alcohol resins.

The temperature of the subterranean formation in which the coating will be used may affect selection of a suitable resin-type coating material. By way of example, for subterranean formations having a bottom hole static temperature (“BHST”) ranging from about 60° F. to about 250° F., two-component epoxy-based resins comprising a hardenable resin component and a hardening agent component may be preferred. For subterranean formations having a BHST ranging from about 300° F. to about 600° F., a furan-based resin may be preferred. For subterranean formations having a BHST ranging from about 200° F. to about 400° F., either a phenolic-based resin or a one-component HT epoxy-based resin may be suitable. For subterranean formations having a BHST of at least about 175° F., a phenol/phenol formaldehyde/furfuryl alcohol resin may also be suitable.

One resin-type coating material suitable for use in the methods of the present invention is a two-component epoxy based resin comprising a hardenable resin component and a hardening agent component. The hardenable resin component is comprised of a hardenable resin and an optional solvent. The solvent may be added to the resin to reduce its viscosity for ease of handling, mixing and transferring. It is within the ability of one skilled in the art, with the benefit of this disclosure, to determine if and how much solvent may be needed to achieve a viscosity suitable to the subterranean conditions. Factors that may affect this decision include geographic location of the well and the surrounding environmental conditions. An alternate way to reduce the viscosity of the liquid hardenable resin is to heat it. This method avoids the use of a solvent altogether, which may be desirable in some circumstances. The second component of the two-component epoxy based resin is the liquid hardening agent component, and it is comprised of a hardening agent, a silane coupling agent, a surfactant, an optional hydrolyzable ester for, inter alia, breaking gelled fracturing fluid films on the proppant particulates, and an optional liquid carrier fluid for, inter alia, reducing the viscosity of the liquid hardening agent component. It is within the ability of one skilled in the art, with the benefit of this disclosure, to determine if and how much liquid carrier fluid is needed to achieve a viscosity suitable to the subterranean conditions.

Examples of hardenable resins that can be used in the liquid hardenable resin component include, but are not limited to, organic resins such as bisphenol A-epichlorohydrin resin, polyepoxide resin, novolak resin, polyester resin, phenol-aldehyde resin, urea-aldehyde resin, furan resin, urethane resin, glycidyl ethers and mixtures thereof. Of these, bisphenol A-epichlorohydrin resin is preferred. The resin used is included in the liquid hardenable resin component in an amount sufficient to consolidate the coated particulates. In some embodiments of the present invention, the resin used is included in the liquid hardenable resin component in the range of from about 70% to about 100% by weight of the liquid hardenable resin component.

Any solvent that is compatible with the hardenable resin and achieves the desired viscosity effect is suitable for use in the present invention. Preferred solvents are those having high flash points (most preferably about 125° F.) due in part to safety concerns. As described above, use of a solvent in the hardenable resin composition is optional but may be desirable to reduce the viscosity of the hardenable resin component for a variety of reasons including ease of handling, mixing, and transferring. It is within the ability of one skilled in the art, with the benefit of this disclosure, to determine if and how much solvent is needed to achieve a suitable viscosity. Solvents suitable for use in the present invention include, but are not limited to, butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, methanol, butyl alcohol, d'limonene and fatty acid methyl esters.

Examples of the hardening agents that can be used in the liquid hardening agent component of the two-component epoxy based coating material of the present invention include, but are not limited to, amines, aromatic amines, polyamines, aliphatic amines, cyclo-aliphatic amines, amides, polyamides, 2-ethyl-4-methyl imidazole and 1,1,3-trichlorotrifluoroacetone. Selection of a preferred hardening agent depends, in part, on the temperature of the formation in which the hardening agent will be used. By way of example and not of limitation, in subterranean formations having a temperature from about 60° F. to about 250° F., amines and cyclo-aliphatic amines such as piperidine, triethylamine, N,N-dimethylaminopyridine, benzyldimethylamine, tris(dimethylaminomethyl) phenol, and 2-(N₂N-dimethylaminomethyl)phenol are preferred with N,N-dimethylaminopyridine most preferred. In subterranean formations having higher temperatures, 4,4′-diaminodiphenyl sulfone may be a suitable hardening agent. In some embodiments of the present invention, the hardening agent used is included in the liquid hardenable resin component in the range of from about 40% to about 60% by weight of the liquid hardening agent component.

The silane coupling agent may be used, inter alia, to act as a mediator to help bond the resin to the sand surface. Examples of silane coupling agents that can be utilized in the liquid hardening agent component of the two-component consolidation fluids of the present invention include, but are not limited to, n-2-(aminoethyl)-3-aminopropyltrimethoxysilane, 3-glycidoxypropyltrimethoxysilane, and n-beta-(aminoethyl)-gamma-aminopropyl trimethoxysilane. The silane coupling agent used is included in the liquid hardening agent component in an amount capable of sufficiently bonding the resin to the particulate. In some embodiments of the present invention, the silane coupling agent used is included in the liquid hardenable resin component in the range of from about 0.1% to about 3% by weight of the liquid hardening agent component.

Any surfactant compatible with the liquid hardening agent may be used in the present invention. Such surfactants include, but are not limited to, an ethoxylated nonyl phenol phosphate ester, mixtures of one or more cationic surfactants, and one or more non-ionic surfactants and an alkyl phosphonate surfactant. The mixtures of one or more cationic and nonionic surfactants are described in U.S. Pat. No. 6,311,733, issued to Todd et al. on Nov. 6, 2001, the relevant disclosure of which is incorporated herein by reference. A C₁₂-C₂₂ alkyl phosphonate surfactant is preferred. The surfactant or surfactants used are included in the liquid hardening agent component in an amount in the range of from about 2% to about 15% by weight of the liquid hardening agent component.

Use of a diluent or liquid carrier fluid in the hardenable resin composition is optional and may be used to reduce the viscosity of the hardenable resin component for ease of handling, mixing and transferring. It is within the ability of one skilled in the art, with the benefit of this disclosure, to determine if and how much liquid carrier fluid is needed to achieve a viscosity suitable to the subterranean conditions. Any suitable carrier fluid that is compatible with the hardenable resin and achieves the desired viscosity effects is suitable for use in the present invention. The liquid carrier fluids that can be used in the liquid hardening agent component of the two-component epoxy based coating material of the present invention preferably include those having high flash points (most preferably above about 125° F.). Examples of liquid carrier fluids suitable for use in the present invention include, but are not limited to, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, d'limonene and fatty acid methyl esters.

Another resin-type coating material suitable for use in the methods of the present invention is a furan-based resin. Suitable furan-based resins include, but are not limited to, furfuryl alcohol, a mixture of a furfuryl alcohol with an aldehyde, and a mixture of a furan resin and a phenolic resin. The furan-based resin may be combined with a solvent to control viscosity if desired. Suitable solvents for use in the furan-based consolidation fluids of the present invention include, but are not limited to 2-butoxy ethanol, butyl acetate, and furfuryl acetate.

Still another resin-type coating material suitable for use in the methods of the present invention is a phenolic-based resin. Suitable phenolic-based resins include, but are not limited to, terpolymers of phenol, phenolic formaldehyde resins, and a mixture of phenolic and furan resins. The phenolic-based resin may be combined with a solvent to control viscosity if desired. Suitable solvents for use in the phenolic-based consolidation fluids of the present invention include, but are not limited to butyl acetate, butyl lactate, furfuryl acetate, and 2-butoxy ethanol.

Another resin-type coating material suitable for use in the methods of the present invention is a HT epoxy-based resin. Suitable HT epoxy-based components included, but are not limited to, bisphenol A-epichlorohydrin resin, polyepoxide resin, novolac resin, polyester resin, glycidyl ethers and mixtures thereof. The HT epoxy-based resin may be combined with a solvent to control viscosity if desired. Suitable solvents for use with the HT epoxy-based resins of the present invention are those solvents capable of substantially dissolving the HT epoxy-resin chosen for use in the consolidation fluid. Such solvents include, but are not limited to, dimethyl sulfoxide and dimethyl formamide. A co-solvent such as dipropylene glycol methyl ether, dipropylene glycol dimethyl ether, dimethyl formamide, diethylene glycol methyl ether, ethylene glycol butyl ether, diethylene glycol butyl ether, propylene carbonate, d'limonene and fatty acid methyl esters, may also be used in combination with the solvent.

Yet another resin-type coating material suitable for use in the methods of the present invention is a phenol/phenol formaldehyde/furfuryl alcohol resin comprising from about 5% to about 30% phenol, from about 40% to about 70% phenol formaldehyde, from about 10 to about 40% furfuryl alcohol, from about 0.1% to about 3% of a silane coupling agent, and from about 1% to about 15% of a surfactant. In the phenol/phenol formaldehyde/furfuryl alcohol resins suitable for use in the methods of the present invention, suitable silane coupling agents include, but are not limited to, n-2-(aminoethyl)-3-aminopropyltrimethoxysilane, 3-glycidoxypropyltrimethoxysilane, and n-beta-(aminoethyl)-gamma-aminopropyl trimethoxysilane. Suitable surfactants include, but are not limited to, an ethoxylated nonyl phenol phosphate ester, mixtures of one or more cationic surfactants, and one or more non-ionic surfactants and an alkyl phosphonate surfactant.

In addition to resin-type coating materials, tackifying coating materials also may be used in the methods and compositions of the present invention. Compounds suitable for use as a tackifying coatings in the present invention comprise substantially any compound that, when in liquid form or in a solvent solution, will form a non-hardening coating upon a particulate. A particularly preferred group of tackifying coatings comprise polyamides that are liquids or in solution at the temperature of the subterranean formation such that the polyamides are, by themselves, sticky and yet non-hardening. A particularly preferred product is a condensation reaction product comprised of commercially available polyacids and a polyamine. Such commercial products include compounds such as mixtures of C₃₆ dibasic acids containing some trimer and higher oligomers and also small amounts of monomer acids that are reacted with polyamines. Other polyacids include trimer acids, synthetic acids produced from fatty acids, maleic anhydride and acrylic acid and the like. Such acid compounds are commercially available from companies such as Witco Corporation, Union Camp, Chemtall, and Emery Industries. The reaction products are available from, for example, Champion Technologies, Inc. and Witco Corporation. Additional compounds which may be utilized as tackifying compounds include liquids and solutions of, for example, polyesters, polycarbonates and polycarbamates, natural resins such as shellac and the like. Suitable tackifying coatings are described in U.S. Pat. No. 5,853,048 issued to Weaver, et al. and U.S. Pat. No. 5,833,000 issued to Weaver, et al., the relevant disclosures of which are herein incorporated by reference.

In certain embodiments of the present invention, the density-reducing material is a plurality of low-density micro-material, smaller in size than the particulate itself. Such a density-reducing material may be any micro-material suitable for use in subterranean applications. As referred to herein, the term “micro-material” will be understood to mean any body that is on average less than about half the size of the proppant or gravel. While low-density micro-material suitable for use in the present invention may be essentially spherical in shape, that geometry is not essential, they may be in any form, including that of regular or irregular pellets, fibers, spheres, flakes, ribbons, beads, shavings, platelets and the like. The term “low-density” as used herein refers to a material having a low specific gravity as compared with a conventional proppant or gravel particulate, such that when adhered to such a proppant or gravel particulate, the material contributes to reducing the overall density of the particulate.

In some embodiments of the methods of the present invention, the micro-material used is a synthetic, non-porous microsphere. Such microspheres may be obtained from any suitable source. Particularly suitable microspheres are cenospheres, which are hollow microspheres formed as an industrial waste by-product, and which are commercially available from, for example, Halliburton Energy Services, Inc., of Duncan, Okla., under the tradename “SPHERELITE.” Generally speaking, the micro-material is included with the proppant or gravel particulates in the amount suitable to reduce the density of the proppant or gravel particulate. In some embodiments, the micro-material is present in an amount from about 1% by weight of the particulate to about 100% by weight of the particulates, preferably from about 10% to about 30% by weight of the particulates.

In another embodiment of the present invention, the density-reducing material may be low-density material similar in size to the particulate itself. Suitable such materials include any solid material that is, on average, greater than about half the size of the proppant or gravel particulate and having a low specific gravity as compared with the proppant or gravel particulate, such that when adhered to the particulate, they contribute to reducing it's overall density. As with suitable low-density micro-materials, while low-density materials suitable for use in the present invention may be essentially spherical in shape, that geometry is not essential, they may be in any form, including that of regular or irregular pellets, fibers, spheres, flakes, ribbons, beads, shavings, platelets and the like. Examples of these low-density materials are polystyrene divinylbenzene plastic beads from suppliers such as ATS Incorporated, Dow Chemical, Sun Drilling Products, etc. These particular polystyrene divinylbenzene plastic beads are commercially available, for example, as a lubrication or torque reduction aid for drilling fluids from ATS Incorporated under the brand name “AT SLIDE (FINE),” or from Sun Drilling Products under the brand name “LUBRAGLIDE,” or as an ion exchange beads manufactured by Dow Chemical.

Where the density-reducing material of the present invention is a plurality of micro-material, the micro-material may be adhered to the particulate surface with a curable resin-type coating. The majority of the micro-material in preferred embodiments should be firmly attached to the particulate's surface. It is undesirable for the micro-material to release from the surface of the particulate once in the subterranean formation as it could potentially plug the porosities of the formation and hinder hydrocarbon production.

Where the density-reducing material of the present invention is a plurality of low-density material similar in size to the particulate itself, the low-density material may be adhered to the particulate surface with either a resin-type coating or a tackifying coating. In certain circumstances, while a tackifying coating is capable of adhering density-reducing material to a particulate, it may not be able to insure that the density-reducing material remains adhered over time, and thus may not be the preferred material in such instances. On the other hand, in certain circumstances, where low-density material similar in size to the particulate itself is used as the density-reducing material, if the low-density material is released over time, it is not likely to cause a problem of plugging pore spaces within the subterranean formation. Thus, a tackifying coating may be used in the methods of the present invention to adhere low-density material similar in size to the particulate itself.

Where a curable resin-type coating is used, the density-reducing material must be adhered while the resin is tacky enough to hold the density-reducing material to the surface of the particulate. By its nature, a tackifying coating will always exhibit sufficient tackiness to adhere the density-reducing material to the surface of the particulate.

Where the reduced-density, coated particulates of the present invention are used in a subterranean treatment, any known servicing fluid, such as a fracturing or delivery fluid, may be used in accordance with the present invention. Acceptable servicing fluids include aqueous gels, emulsions, foams, and other fluid types known in the art. The aqueous gels are generally comprised of water and one or more gelling agents. The emulsions can be comprised of two immiscible liquids such as an aqueous gelled liquid and a liquefied, normally gaseous fluid, such as nitrogen. The servicing fluid needs only to be viscous enough to substantially suspend the reduced-density particulate of the present invention. In most embodiments, highly viscous fluids, although suitable, are not necessary. Lower concentrations of polymer can be used to effectively transport reduced density particulates.

In some embodiments of the present invention, the reduced-density, coated particulates are created on-the-fly. The term “on-the-fly” is used herein to mean that a flowing stream is continuously introduced into another flowing stream so that the streams are combined and mixed while continuing to flow as a single stream as part of the on-going treatment. Such mixing can also be described as “real-time” mixing. On-the-fly mixing, as opposed to batch or partial batch mixing, reduces waste and simplifies subterranean treatments. For instance, where a two-component epoxy based resin comprising a hardenable resin component and a hardening agent component is used, the liquid hardenable resin component and liquid hardening agent component may be combined on-the-fly and then coated directly onto the particulate on-the-fly and then that coated particulate can be further coated with a density-reducing material on-the-fly. In that case, such a process is advantageous, as least in part, because once the liquid hardenable resin component and liquid hardening agent component are mixed, the mixture must be used quickly or the resin will cure and the mixture will no longer be tacky enough to adhere a density-reducing material to the particulate. Thus, if the components are mixed and then circumstances dictate that the subterranean treatment be stopped or postponed, the mixed components may become unusable. By having the ability to rapidly shut down the mixing of the hardenable resin composition components on-the-fly, this waste can be avoided, resulting in, inter alia, increased efficiency and cost savings.

It is desirable to have the density-reducing materials to coat or adhere properly onto the surface of the coated particulate, so that there is no excess of these materials floating freely in the matrix of reduced-density coated particulate, which may result in a pack bed with reduced permeability. In preferred embodiments, excess density-reducing materials may be removed from the reduced-density, coated particulates by sieving, grading, or some similar means before the coated particulates are mixed in with a serving fluid.

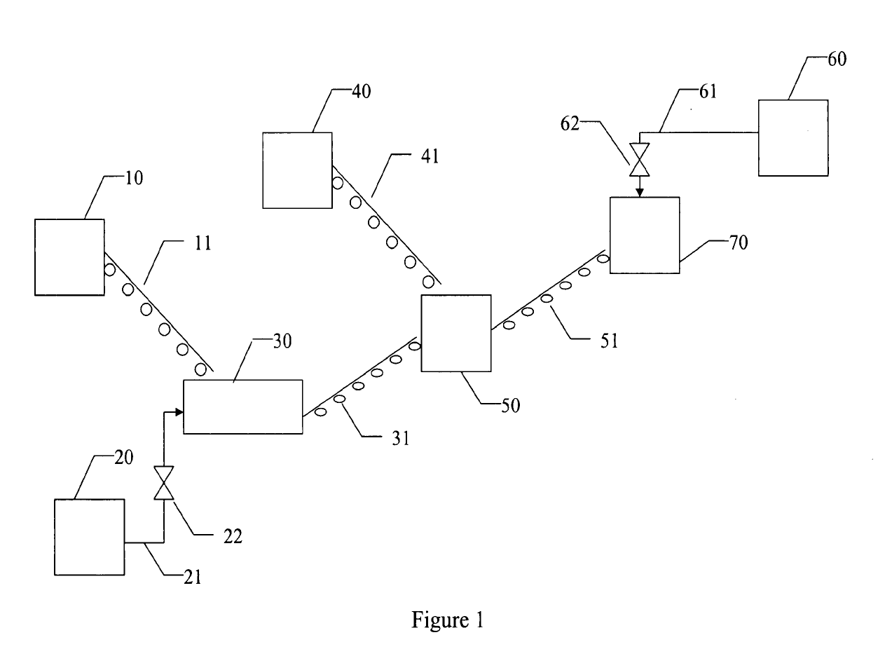

FIG. 1 illustrates one embodiment of an on-the-fly mixing method of the present invention. Changes in the equipment and arrangement as shown in FIG. 1 are possible and within the ability of one skilled in the art with the benefit of this disclosure. Container 10 holds particulate matter such as proppant or gravel. Conveyance means 11 can be any means known in the art for conveying the particulate material. In one embodiment of the present invention, conveyance means 11 comprises a conveyor belt or a sand screw. Conveyance means 11 transports the particulate to container 30. Container 20 holds either a tackifying agent or a resin and line 21 transports the contents of container 20 to container 30. Control of the total and relative amounts of tackifying agent or resin is achieved through the use of valve 22 on line 21 and of the particulate through the control of conveyance means 11. Inside container 30, the particulates from container 10 are coated with tackifying agent or resin from container 20 to form coated particulates. The coated particulates exit container 30 via conveyance means 31. Where conveyance means 31 is a sand screw, the proppant may be coated with the tackifying agent or resin by the auger action of the sand screw itself. Conveyance means 31 transports the coated particulates to container 50. In one embodiment, the transport of the coated particulates from container 30 to container 50 is computer-controlled to ensure accurate metering and to allow for a rapid shutdown of on-the-fly mixing when necessary. Also transported to container 50 is a density-reducing material of the present invention. The density-reducing material of the present invention is held in container 40 and transported to container 50 via conveyance means 41. Conveyance means 41 can be any means known in the art for conveying particulate material, in one embodiment of the present invention, conveyance means 41 comprises a conveyor belt or a sand screw. Control of the total and relative amounts of coated particulates and density-reducing material is achieved by controlling the conveyance rates of conveyance means 31 and conveyance means 41. Inside container 50, the coated particulates 30 are again coated, this time with density-reducing material from container 40, to form reduced-density, coated particulates. The reduced-density, coated particulates exit container 50 via conveyance means 51. Conveyance means 51 can be any means known in the art for conveying particulate material, in one embodiment of the present invention, conveyance means 51 comprises a conveyor belt or a sand screw.

Where it is desirable to immediately use the reduced-density, coated particulates in a subterranean treatment, they may be transported by conveyance means 51 directly from container 50 to blender tub 70. In one embodiment, the transport of reduced-density, coated particulates from container 50 to blender tub 70 is computer-controlled to ensure accurate metering and to allow for a rapid shutdown of on-the-fly mixing when necessary. Also transported to blender tub 70 is a servicing fluid from container 60. The servicing fluid from container 60 may be transported to blender tub 70 by any means known in the art. In one embodiment, the transport of servicing fluid from container 60 to blender tub 70 is computer-controlled to ensure accurate metering and to allow for a rapid shutdown of on-the-fly mixing when necessary. Inside blender tub 70, the servicing fluid is substantially mixed with reduced-density, coated particulates to form a blended composition suitable for use in subterranean fractures.

Therefore, the present invention is well adapted to carry out the objects and attain the ends and advantages mentioned as well as those that are inherent therein. While numerous changes may be made by those skilled in the art, such changes are encompassed within the spirit and scope of this invention as defined by the appended claims.

1.-64. (canceled)

65. A method of making a reduced-density, coated particulate comprising the steps of:
providing a first flowing stream comprising particulates coated with a coating material selected from the group consisting of a tackifying agent and a resin-type material;
providing a second flowing stream comprising a density reducing material wherein the density reducing material is a solid material with a size that is greater than about half of the size of the coated particulates;
combining the first and second flowing streams to create a third flowing stream wherein the combination of the first and second flowing streams causes the density reducing material to adhere to the coating material on the particulates so as to create reduced-density, coated particulates.

66. The method of claim 65 wherein the resin-type material comprises a two-component epoxy based resin comprising a hardenable resin component and a hardening agent component.

67. The method of claim 65 wherein the resin-type material comprises a furan-based resin comprising a material selected from the group consisting of: furfuryl alcohol; a mixture of furfuryl alcohol with an aldehyde; a mixture of furan resin and phenolic resin; or combinations thereof.

68. The method of claim 67 further comprising a solvent selected from the group consisting of: 2-butoxy ethanol, butyl acetate; furfuryl acetate; or combinations thereof.

69. The method of claim 65 wherein the resin-type material comprises a phenolic-based resin selected from the group consisting of: terpolymer of phenol; phenolic formaldehyde resin; a mixture of phenolic and furan resin; or combinations thereof.

70. The method of claim 69 wherein the resin-type material further comprises a solvent selected from the group consisting of: butyl acetate; butyl lactate; furfuryl acetate; 2-butoxy ethanol; or combinations thereof.

71. The method of claim 65 wherein the resin-type material comprises an HT epoxy-based resin comprising: bisphenol A-epichlorohydrin resin;
polyepoxide resin; novolac resin; polyester resin; glycidyl ethers; or combinations thereof.

72. The method of claim 71 wherein the resin-type material further comprises a solvent selected from the group consisting of: dimethyl sulfoxide;
dimethyl formamide; dipropylene glycol methyl ether; dipropylene glycol dimethyl ether; dimethyl formamide; diethylene glycol methyl ether; ethylene glycol butyl ether; diethylene glycol butyl ether; propylene carbonate; d'limonene; fatty acid methyl esters; or combinations thereof.

73. The method of claim 65 wherein the resin-type material comprises a phenol/phenol formaldehyde/furfuryl alcohol resin comprising from about 5% to about 30% phenol, from about 40% to about 70% phenol formaldehyde, from about 10 to about 40% furfuryl alcohol, from about 0.1% to about 3% of a silane coupling agent, and from about 1% to about 15% of a surfactant.

74. The method of claim 65 wherein the tackifying agent comprises a polyamide; a polyester; a polycarbonate; a polycarbamate; a natural resin; or a combination thereof.

75. The method of claim 65 wherein the density-reducing material comprises polystyrene divinylbenzene beads.

76. The method of claim 65 further comprising the steps of, after adhering the density-reducing material to the surface of the coated particulate on-the-fly:
providing a servicing fluid; and,
suspending the reduced-density, coated particulates in the servicing fluid.

77. A method of making a servicing fluid comprising a reduced-density, coated particulate comprising the steps of:
providing a first flowing stream comprising particulates coated with a coating material selected from the group consisting of a tackifying agent and a resin-type material;
providing a second flowing stream comprising a density reducing material wherein the density reducing material comprises solid polystyrene divinylbenzene beads with a size that is greater than about half of the size of the coated particulates;
combining the first and second flowing streams to create a third flowing stream wherein the combination of the first and second flowing streams causes the density reducing material to adhere to the coating material on the particulates so as to create reduced-density, coated particulates;
providing a fourth flowing stream comprising a servicing fluid; and,
combining the third and fourth flowing streams to create a fifth flowing stream comprising reduced-density, coated particulates suspended in the servicing fluid.

78. The method of claim 77 wherein the resin-type material comprises a two-component epoxy based resin comprising a hardenable resin component and a hardening agent component.

79. The method of claim 77 wherein the resin-type material comprises a furan-based resin comprising a material selected from the group consisting of: furfuryl alcohol; a mixture furfuryl alcohol with an aldehyde; a mixture of furan resin and phenolic resin; or combinations thereof.

80. The method of claim 77 wherein the resin-type material comprises a phenolic-based resin selected from the group consisting of: terpolymer of phenol; phenolic formaldehyde resin; a mixture of phenolic and furan resin; or combinations thereof.

81. The method of claim 77 wherein the resin-type material comprises an HT epoxy-based resin comprising: bisphenol A-epichlorohydrin resin; polyepoxide resin; novolac resin; polyester resin; glycidyl ethers; or combinations thereof.

82. The method of claim 77 wherein the resin-type material comprises a phenol/phenol formaldehyde/furfuryl alcohol resin comprising from about 5% to about 30% phenol, from about 40% to about 70% phenol formaldehyde, from about 10 to about 40% furfuryl alcohol, from about 0.1% to about 3% of a silane coupling agent, and from about 1% to about 15% of a surfactant.

83. The method of claim 77 wherein the tackifying agent comprises a polyamide; a polyester; a polycarbonate; a polycarbamate; a natural resin; or a combination thereof.
